(19) United States
(12) Patent Application Publication
(10) Pub. No.: US 2024/0112822 A1
(43) Pub. Date: Apr. 4, 2024

(54) Nuclear Reactor Neutron Reflector

(71) Applicant: X-energy, LLC, Rockville, MD (US)

(72) Inventors: Timothy Ryan LUCAS, Arlington, VA (US); Michael SAITTA, Alexandria, VA (US); Gwennaël BEIRNAERT, Alexandria, VA (US); Martin Peter VAN STADEN, Rockville, MD (US)

(21) Appl. No.: 17/958,363

(22) Filed: Oct. 1, 2022

(51) Int. Cl. G21C 11/06

(52) U.S. Cl. CPC G21C 11/06

(57) ABSTRACT

A neutron reflector design which lowers stress in inner reflector members by supporting the inner reflector members on radially adjacent outer reflector members at the interface between the inner and outer reflector members, such that an individual inner reflector member is not supported by an inner reflector member in a layer of the reflector assembly immediately below, and the inner reflector member does not have to bear a load from an inner reflector member in a layer of the reflector assembly immediately above. The lowering of the load carried by the individual inner reflector members with this individual-member-support arrangement reduces stress-induced reflector damage with is enhanced in the high radiation flux environment adjacent to a nuclear reactor core. The inner reflector members are removable for replacement without the need to remove the outer reflector members.

This invention was made with government support under contract no. DE-NE0009040 awarded by the Department of Energy. The government has certain rights in the invention.

### BACKGROUND

Carbon has been used in gas-cooled nuclear reactors, primarily in the form of graphite. Graphite is an anisotropic crystalline form of carbon in which planar layers of strongly covalent-bonded carbon rings are held together by relatively weak Van der Waals interactions between the layers. The weaker bonds provide relatively weak shear strength. When irradiated by neutrons, some carbon atoms are displaced, creating vacancies in the crystal lattice and lodging of atoms in interstitial sites. Particularly at elevated temperatures, mobility is increased and the atom movement can result in lattice size changes and associated unidirectional swelling as the weaker Van der Walls bonds typically are broken before the strong covalent bonds in the planar layers. Carbon is also known to degrade due to oxidation at higher temperatures, which can increase the rate of dimensional change and substantially decrease material strength.

A neutron reflecting structure, for example a structure formed from carbon in the form of graphite, may be placed into a reactor vessel to reflect neutrons emitted in fission events back into the reactor core. Reflecting neutrons in this manner can reduce irradiation of materials outside of the core (e.g., the metal of a reactor vessel), provide some degree of neutron moderation, and increase the neutron flux in the region of the reactor core containing fissionable fuel. The increase in neutron flux in the radially-outer regions of the reactor core may be advantageous to help flatten the distribution of neutrons across the core (relative to the neutron flux at the center of the core) and thereby provide more even consumption of the fuel throughout the core.

### SUMMARY

In an embodiment, the neutron reflector includes layers of rings of wedge-shaped outer reflector blocks radially outside counterpart layers of rings of inner reflector blocks. The inner reflector blocks provide partial shielding of the outer reflector blocks to assist in reducing the rate and amount of degradation of the outer blocks. Due to their location, the inner reflector blocks are exposed to the highest amount of neutron radiation from the reactor core.

The inner reflector blocks are individually supported by their respective outer reflector blocks, and they are slightly smaller in vertical height than the outer reflector blocks, to ensure a vertical gap between vertically adjacent inner reflector blocks. This has the significant advantage of eliminating the loading of the inner reflector blocks with the dead weight of the blocks located above them as in previous reflector designs. This approach further enables inner reflector blocks to be removed and replaced in a selective manner, rather than disassembling large portions of the reflector, as it allows the inner reflector blocks to be removed for replacement without the need to remove the outer reflector blocks. This potentially simplifies reflector maintenance, lowers costs, and may help minimize the amount of time the reactor must be shut down between power production cycles.

In one embodiment, the radially-outer surface of an inner reflector block is provided with surface features, such as wedge-shaped protrusions or grooves, which are configured to cooperate with counterpart surface features at a radially-inner surface of an outer reflector block. The complementary surface features have surfaces, preferably angled, arranged such that as an inner reflector block is lowered into position at the radially-inward face of the outer reflector block, the angled surfaces arrest the inner reflector movement at a desired vertical height relative to the outer reflector block. In this arrangement, the outer reflector block supports only the weight of the inner reflector block it is carrying, as the inner reflector blocks which are located vertically in higher layers in the reflector assembly no longer bear on lower inner reflector blocks (the higher inner reflector blocks also being independently supported on their own respective outer reflector blocks). This individual block-support approach substantially reduces, if not completely eliminates, loading stresses in the individual inner reflector blocks, which in turn significantly decreases stress-enhanced radiation-induced degradation of the inner reflector blocks.

The outer reflector block may be sized to support one inner reflector block, or more than one circumferentially adjacent inner reflector blocks. The inner reflector block also may be supported on a stack of two or more partial-height outer reflector blocks, as long as the radially inner-facing surfaces of the partial-height outer reflector blocks, when combined, present the radially outer-facing surface of the inner reflector block with the appropriate inner reflector block support surface features.

The inner reflector blocks may be provided with vertical through-passages which accommodate equipment such as instrumentation or control rods. Preferably the through-passages are provided with insert elements, preferably in the form of generally cylindrical segments having a vertical height compatible with that of the reflector block. The cylindrical segments further may be provided with circumferential flanges and/or lateral protrusions at their upper ends which are configured to cooperate with complementary recesses in the inner reflector blocks to assist in hold-down of the inner reflector blocks when the reflector assembly is complete, with the resulting column of tube-shaped segments in the assembly constraining upward movement of their respective inner reflector blocks relative to the outer reflector blocks.

The inventive reflector block arrangements may also significantly decrease reactor assembly time and effort. In previous reflector designs, the reflector was assembled on its supporting structure (e.g., on supports near the bottom of a core barrel) and had to be built-up layer-by-layer in a block stacking process because each new layer of blocks was supported by the underlying layers. With this approach of supporting each individual inner reflector carbon block on an outer carbon reflector block, any number of layers of blocks may be assembled to form a sub-assembly or segment of reflector block layers. This permits pre-assembly of a subset of reflector block layers away from the reactor vessel, followed by rapid placement of multiple segments one upon another in the reactor vessel to build up the neutron reflector. In a preferred embodiment, the core barrel also may be formed in segments, with each segment sized to accommodate a desired number of reflector block layers in the segment. The remote assembly of the core barrel and reflector block segments away from the reactor vessel potentially results in further savings of time and cost during reactor assembly, as the pre-assembled segments core barrel and reflector may be quickly built up in parallel, and the potentially lighter sub-assemblies may reduce the amount of required crane capacity which must be provided to service the reactor.

The foregoing is not limited by the forgoing summary or following detailed description. For example, it is not limited to reflector blocks formed from carbon. Further, the complementary arrangement of the supporting structure is not limited to the described groove and projections, but includes any structural arrangement which permits the outer reflector blocks to support inner reflector blocks without the inner reflector blocks having to either carry loads from overlaying blocks or be supported from below.

Other objects, advantages and novel features will become apparent from the following detailed description when considered in conjunction with the accompanying drawings.

### BRIEF DESCRIPTION OF THE DRAWINGS

FIGS. 1A and 1B schematically illustrate previous approaches for stacking reflector blocks in a reactor vessel.

FIGS. 2A-2D show perspective and plan views, respectively, of embodiments.

FIGS. 3A and 3B show perspective views of an embodiment of an inner reflector block.

FIG. 4 shows an elevation view of a radially inner surface of the inner reflector block of FIGS. 3A and 3B.

FIG. 5 shows an elevation view of a radially outer surface of the inner reflector block of FIGS. 3A and 3B.

FIG. 6 shows an elevation view of a circumferential side surface of the inner reflector block of FIGS. 3A and 3B.

FIGS. 7A and 7B shows plan views of an upper surface and a lower surface, respectively, of the inner reflector block of FIGS. 3A and 3B.

FIGS. 8A, 8B and 8C shows perspective views of other embodiments of an inner reflector having respective portions of a circular depression in their radially inner surfaces, and a subassembly containing all portions of the circular depression together.

FIG. 9 shows an elevation view of a radially inner side surface of another embodiment the inner reflector block.

FIG. 10 shows a perspective view of another embodiment of inner and outer reflector blocks.

### DETAILED DESCRIPTION

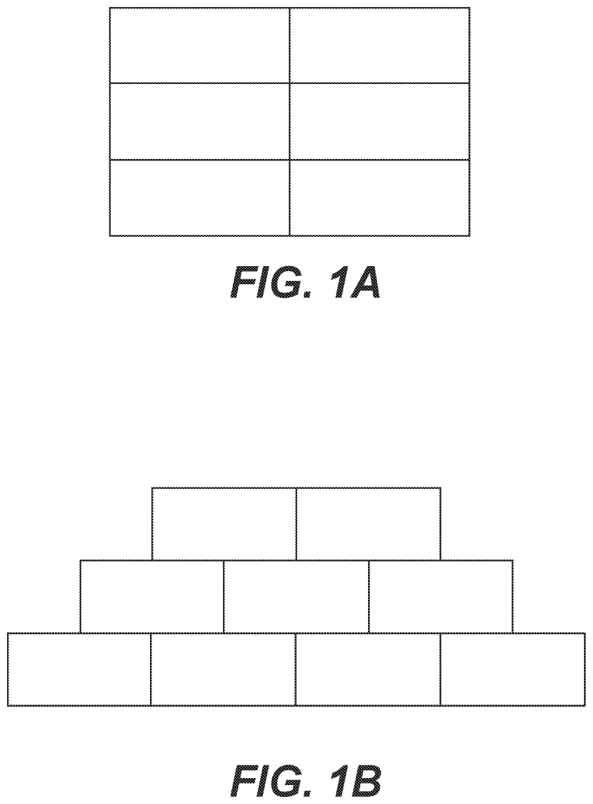

One approach to reflecting neutrons is to locate carbon circumferentially around the reactor core by stack carbon blocks concentrically around a core in a cylindrically-shaped reflector, typically between the core and a cylindrical metal shield placed within the reactor vessel to reduce the nuclear and thermal irradiation of the reactor vessel (aka, a “core barrel”). Examples of previous “stacking” arrangements are schematically illustrated in FIGS. 1A and 1B, where the carbon blocks are directly stacked one upon another, either in vertical alignment or stacked in an offset manner, respectively. For clarify of illustration, in FIGS. 1A and 1B the related structures in and around the carbon blocks are omitted. The FIG. 1B “bridging” block arrangement is not preferred, because block deterioration or other sources of block movement can result in uneven loading of the blocks, concentrating the dead weight load of higher blocks on only a portion of a lower block. This high localized loading can increase the likelihood of block failure from cracking, both from the higher stress on the move heavily loaded portion of a reflector block and the differential loading increasing shear stress between the more heavily loaded and light-loaded portions of the block.

The previous approaches to arranging carbon blocks in a neutron-reflecting array around a reactor core have several disadvantages. Carbon blocks cannot be cemented or otherwise bonded together due to their location in the high temperature and high radiation environment inside a reactor vessel. Accordingly, carbon blocks must be stacked on top of one another, with the result that in the lower blocks in the stack having to bear the dead weight load of all of the carbon blocks stacked above them in the reflector assembly. In a reactor environment, this can lead to significantly reduced reflector block service life, as higher mechanical stress levels may increase the rate of degradation of the carbon blocks in high temperature and high neutron irradiation environments. Such arrangements also have the disadvantage that a large amount of disassembly is required for carbon block replacement during reactor servicing events, including removal of all of a variety of structures which pass vertically through the reflector structure (e.g., instrumentation tubing, control rod and coolant penetration liners), and the need to remove of all of the dead weight of the carbon blocks in a reflector stack above a lower reflector block, before the lower block can be removed.

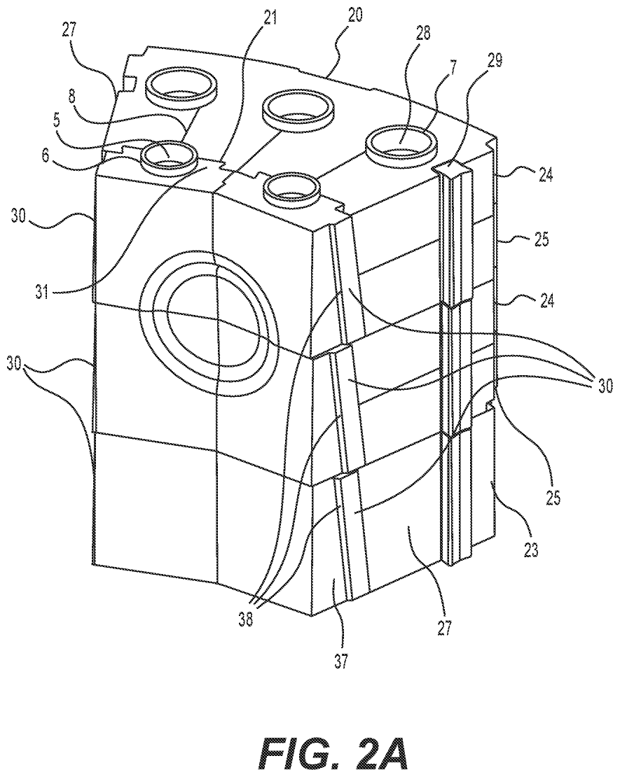

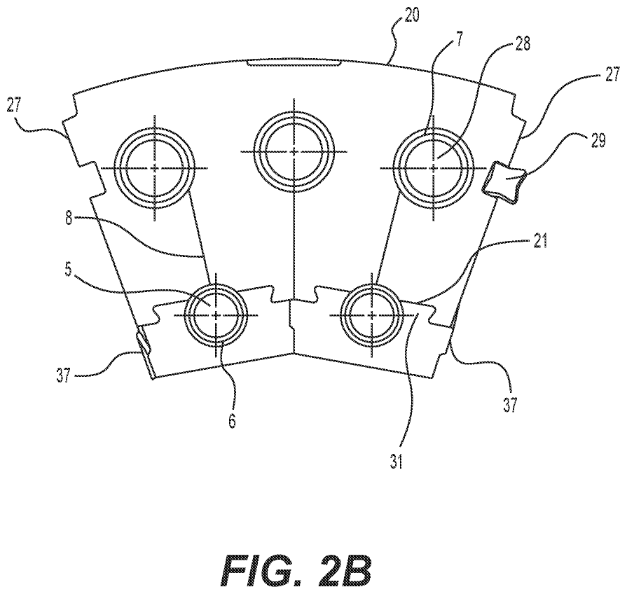

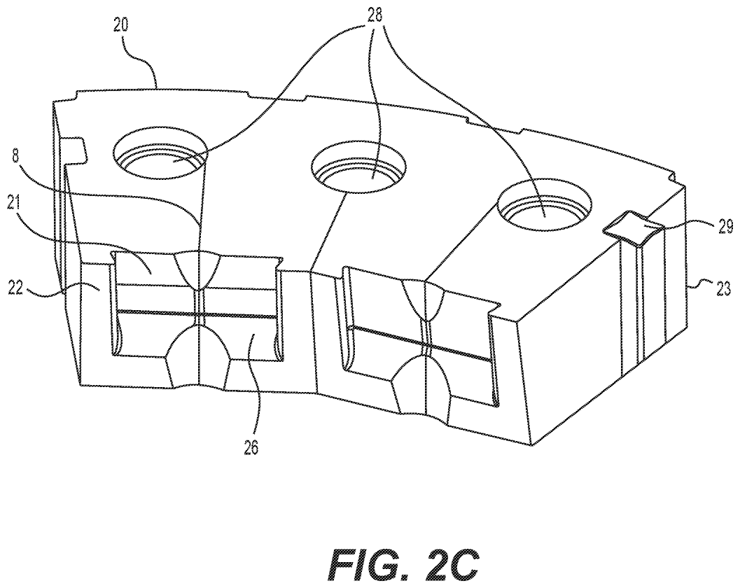

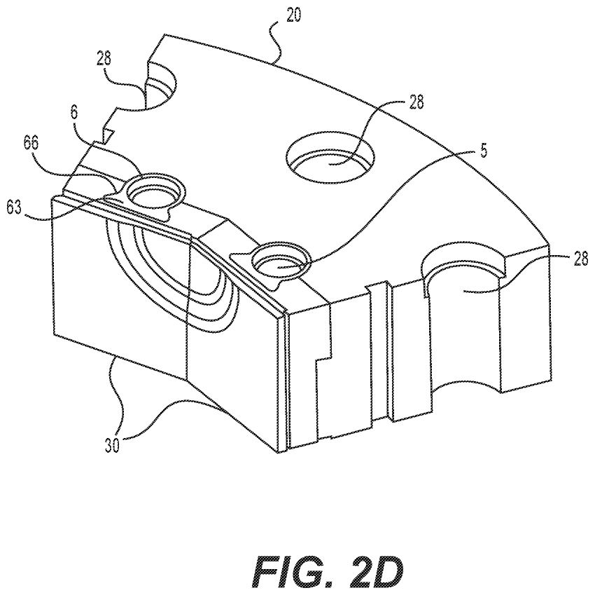

The embodiment shown in FIG. 2A is a perspective view in which inner reflector blocks 30 are supported by outer reflector blocks 20. A plan view of the top surface of this sub-assembly is shown in FIG. 2B. The reflector blocks in this embodiment are formed from graphite, but are is not limited to this particular material.

Visible in FIG. 2A are three layers of outer reflector blocks 20 which are arranged vertically, with each layer supporting two inner reflector blocks. 30. The outer reflector block 20 at the bottom layer is a one-piece block 23, while the middle and top outer reflector blocks 20 are both formed from two partial-height outer reflector blocks 24, 25. These outer reflector blocks are merely illustrative, as any combination of one-piece and multi-piece outer reflector blocks may be used in the reflector assembly layers, or a single type of outer reflector block may be used in all layers.

As shown in both FIGS. 2A and 2B, the inner reflector blocks 30 are supported on the outer reflector blocks 20 by surface features in the form of wedge-shaped projections 31 of the inner reflector block 30 and complementary surface features in the form of grooves 21 of the outer reflector block 20. The inner and outer reflector blocks also are shaped to cooperate to form a vertical through-passage 5, in this embodiment a cylindrical passage with insert elements 6 (aka, inner liner segments) to accommodate equipment such as instrumentation or control rods (the insert elements are discussed further, below). In other embodiments, the through-passage may be entirely within one of the inner or outer reflector blocks, or there may be no passage present.

The reflector blocks in FIGS. 2A and 2B form an arc-shaped portion of a ring of reflector blocks. These figures also show the circumferential sides 27, 37 of the reflector blocks, which are angled generally along radii from the center axis of the reflector block rings so that adjacent reflector blocks will abut and cooperate with one another to form the rings. The outer reflector blocks may also accommodate through passages, such as through-passages 28 for various purposes, such as conducting a cooling medium such as helium gas between different locations in the reactor vessel. Preferably the outer reflector block through-passages are provided with fluid-tight insert elements 7 (aka outer liner elements).

Also shown in this embodiment are vertical slots in the circumferential sides of the outer reflector blocks which accommodate keys 29. The keys 29 may be used to minimize neutron leakage through a gap between adjacent outer reflector blocks, as well as assist in maintaining alignment of the outer reflector blocks over the course of their service lives.

In this embodiment the circumferential sides 37 of the inner reflector blocks 30 are provided with stepped surfaces 38, configured to cooperate with a counterpart stepped surface on a circumferentially adjacent inner reflector block. Examples of these complementary arrangements are visible in FIG. 2B.

FIG. 2C shows a perspective view of an outer reflector block 20, with the outer reflector block through-passages 28. Also shown are curved surface features on the radially-inner surface 22 of the outer reflector block 20 which cooperate with a corresponding curved surface in the radially-outer surface 32 of a inner reflector block 30 to form the through-passage 5. In this embodiment the upper ends of the through-passages 28 in the partial-height outer reflector block 24 have annular recesses which receive at least a portion of the annular flange at the upper ends of the insert elements 7.

Extending from the through-passages 28 to the radially-inner surfaces 22 of the outer reflector block are gaps 8. These gaps also extend from top to bottom of the outer reflector block 20, without any material of the outer reflector block bridging the gaps. The gaps 8 may be formed with appropriate tooling, for example, by use of a saw blade cutting vertically through the outer reflector block. The gaps 8 are provided to reduce stress build up from irradiation, which in turn advantageously permits larger outer reflector blocks 20 to be used to lower radial leakage of cooling medium (e.g., helium) by reducing the number of radial gaps around the circumference of the outer reflector block rings. The use of larger outer reflector blocks may also reduce cost and assembly complexity by reducing the number of parts required to construct the neutron reflector.

FIG. 2D shows an alternative embodiment in which the liner segment 6 is provided with a lateral flange 63 at its upper end. The lateral flange 63 is shaped to fit into a corresponding recess 66 in the top surface of an inner reflector block 30, and serves to inhibit vertical movement of the inner reflector block, with the liner segment 6 in turn being held down by reflector assembly elements above it in the assembly (such as another immediately-above liner segment 6).

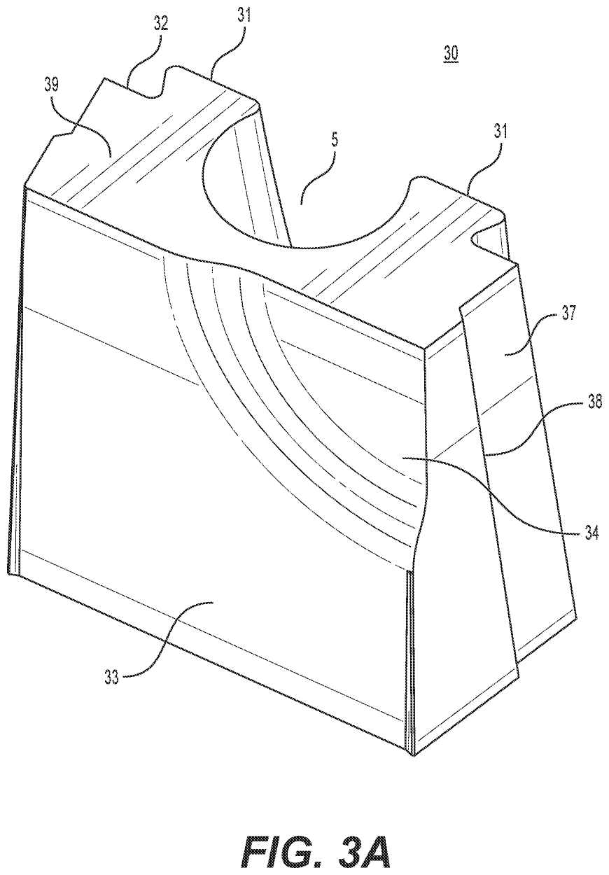

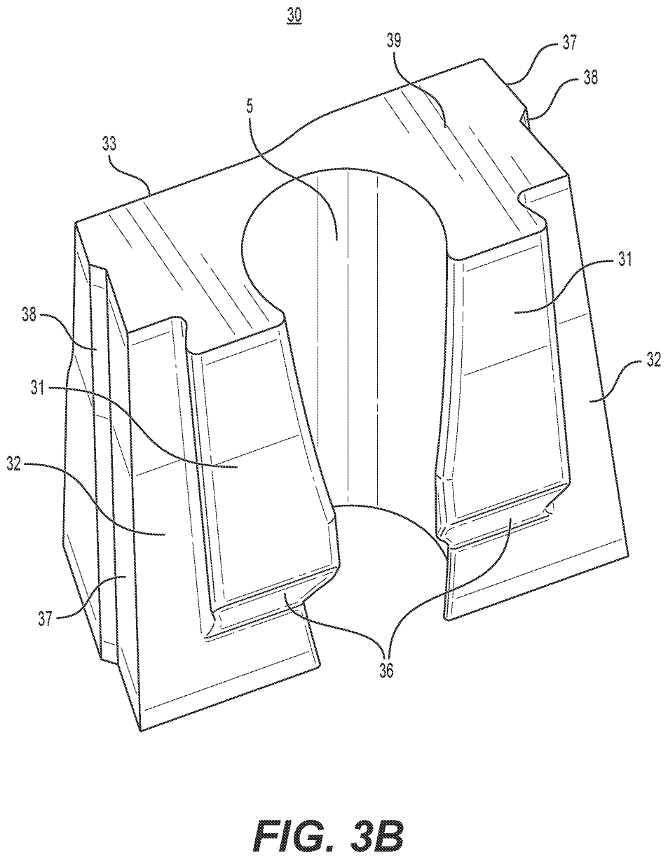

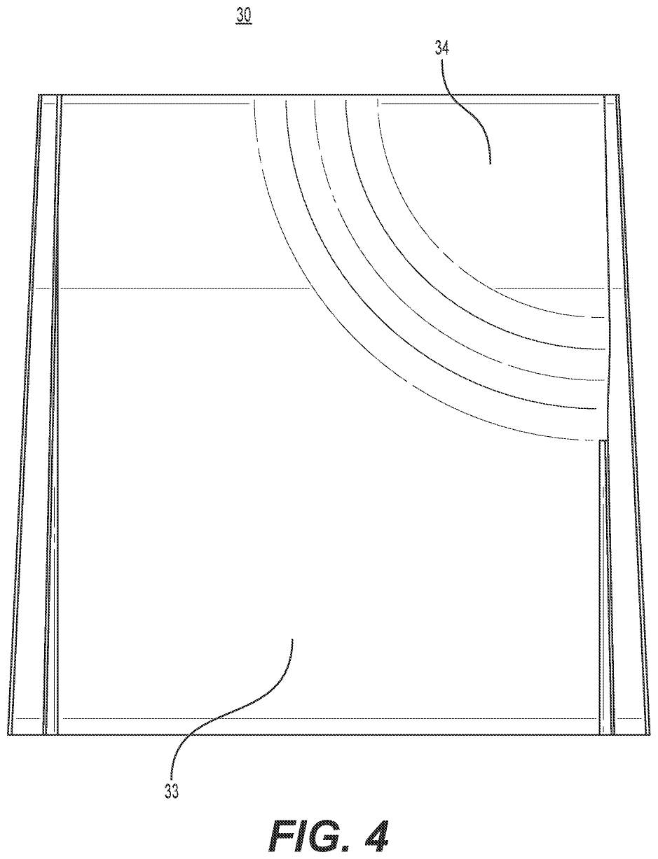

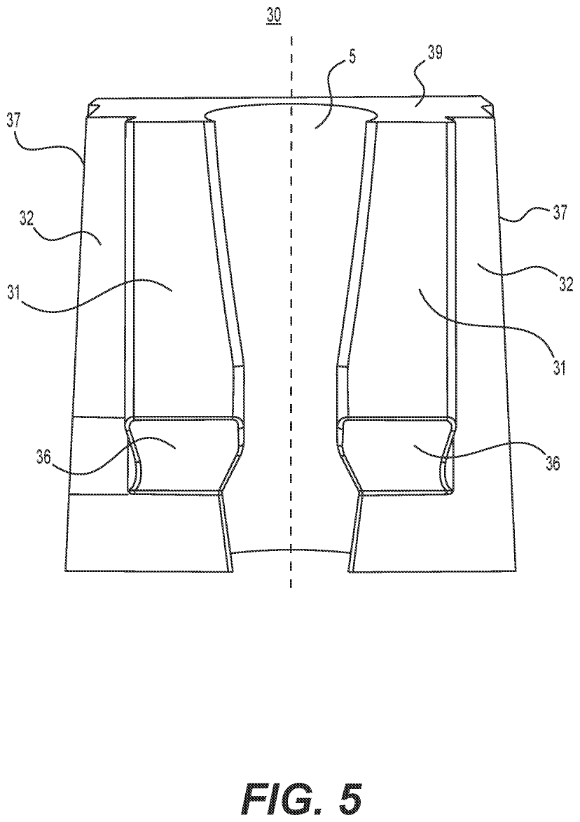

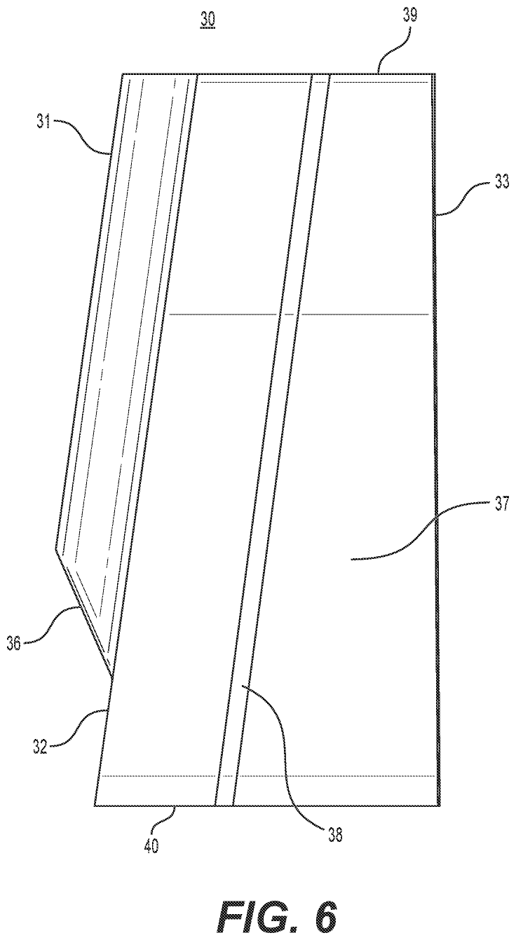

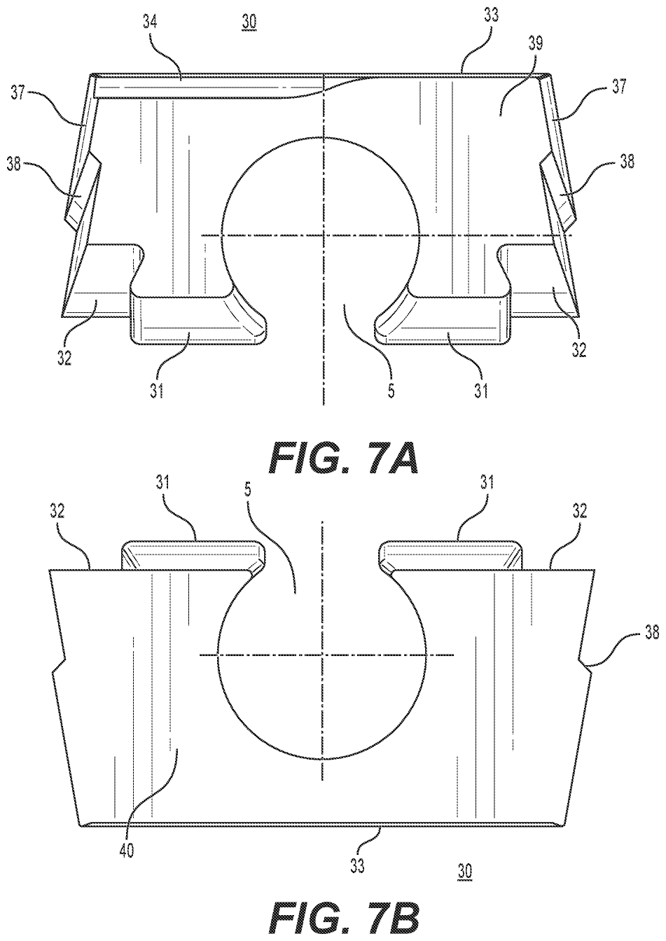

FIGS. 3A and 3B are perspective views focusing on an embodiment of an inner reflector block 30. The inner reflector block 30 has a radially-inner surface 33 which faces a reactor core when in an installed position, and a radially-outer surface 32. FIGS. 4-6 and 7A-7B are illustrations of views of, respectively, the radially inner, radially outer, circumferential, top and bottom sides of the inner reflector embodiment of FIGS. 3A and 3B.

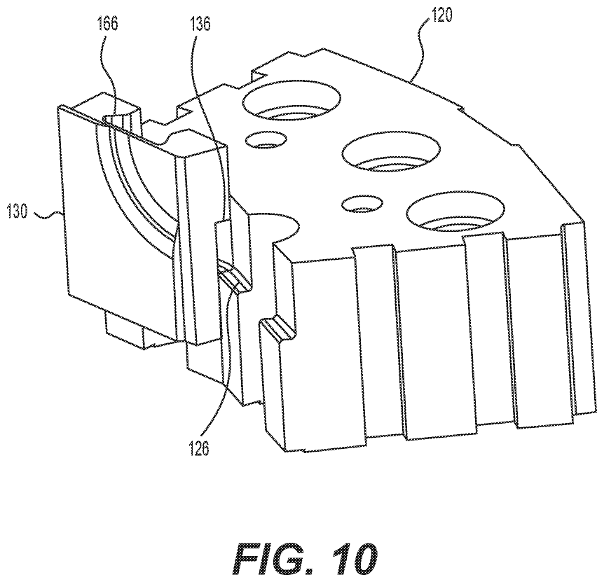

The radially-outer surface 32 of the inner reflector block 30 in this embodiment includes wedge-shaped projections 31 which are configured to cooperate with complementary grooves in a radially-inner surface of an outer reflector block. In this embodiment the wedge-shaped projections 31 have angled stop surfaces 36 at their lower ends, which cooperate with complementary angled surfaces 26 on the radially-inner surface of the outer reflector block which support the weight of the inner reflector block on the outer reflector block. The stop surfaces are not limited to the illustrated angles, and may have different geometries. For example, the stop surfaces may be horizontal steps which come to rest on complementary steps projecting from the respective outer reflector block. Other embodiments include, for example, horizontal steps with recessed angles, such as shown in FIG. 10.

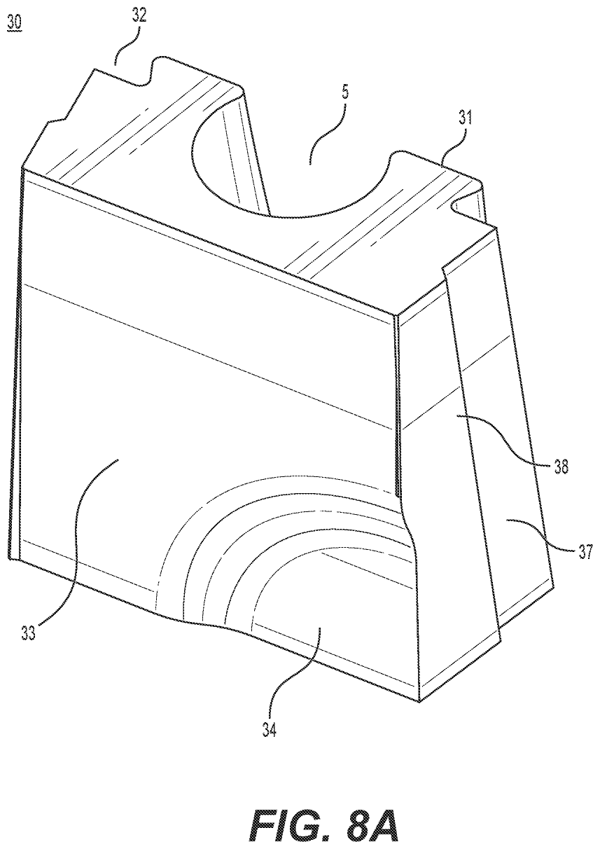

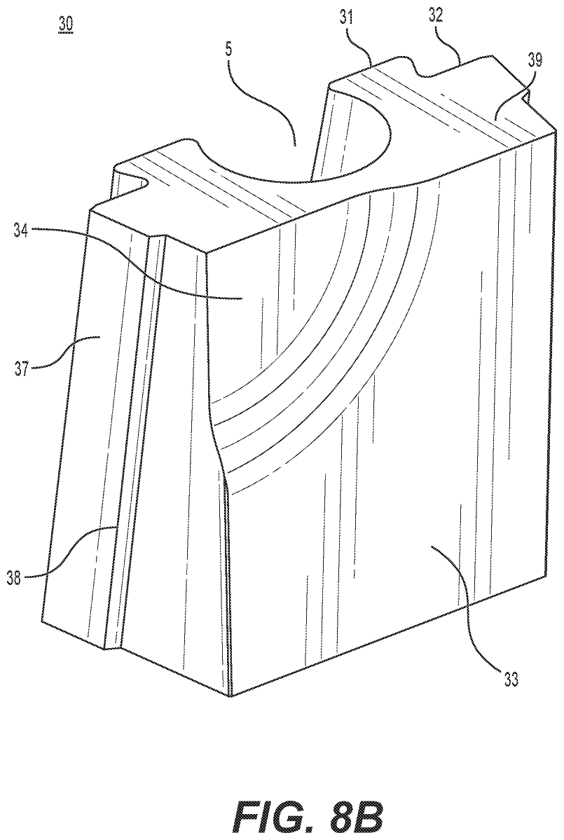

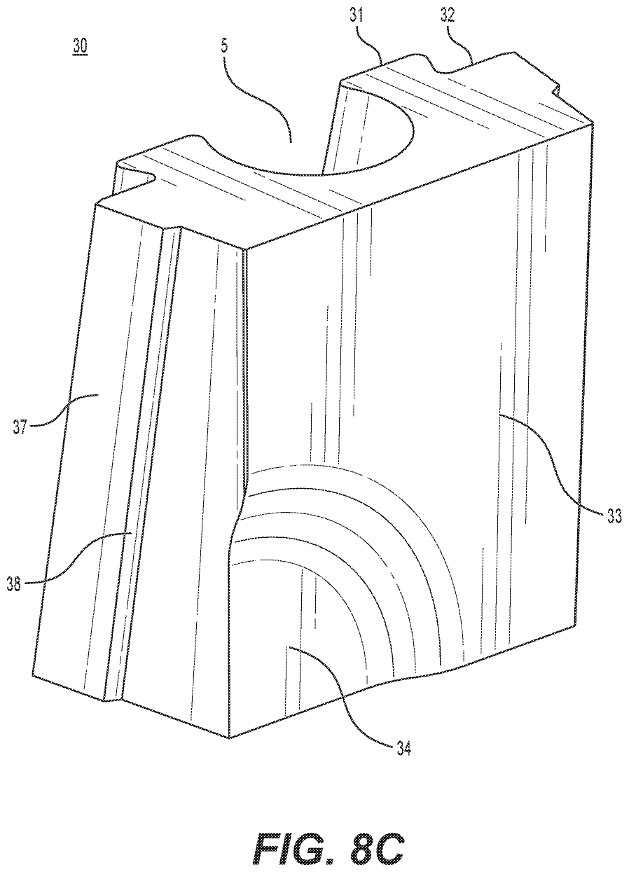

Also in this embodiment, the radially-inner surface 33 includes one-fourth of a circular depression 34 at the upper right-side corner of the radially-inner surface 33. When the inner reflector block 30 of FIGS. 3A and 3B is stacked adjacent to similar inner reflector blocks containing the other three quarters of the circular depression 34 shown in FIGS. 8A, 8B and 8C, a complete circular depression is formed on the reactor core-facing surface of the reflector assembly as shown in FIG. 2A. The purpose of the circular depression is to assist in the vertical movement of reactor fuel in a gas-cooled pebble-bed reactor. This is an optional feature and may be omitted.

The circumferential side surfaces 37 of the inner reflector block 30 are tapered along radii of the reflector block ring to facilitate assembly into of the inner reflector blocks into the ring. Each of the circumferential sides 37 in this embodiment includes a step 38 configured to cooperate with an oppositely-oriented complementary step of a circumferentially adjacent inner reflector block, such as shown in FIG. 2A, to provide a barrier which suppresses neutron leakage through a gap that would otherwise be present if the blocks' abutting circumferential surfaces occur were flat.

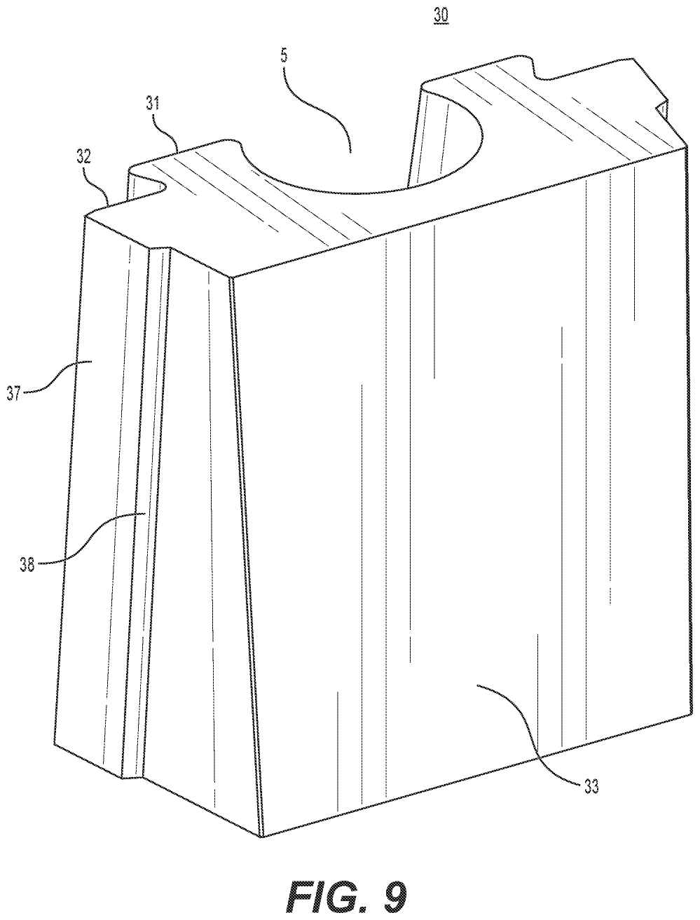

The upper surface 39 and lower surface 40 of the inner reflector block 30 in this embodiment are generally flat surfaces, but they are not limited to solely a flat geometry. For example, the bottom surface 40 may include recesses configured to accommodate upper flanges of the FIG. 2A and FIG. 2B insert elements of the next-lower reflector block layer. Nor are the inner reflector blocks limited to having a smooth-faced radially-inner surface. Other surface configurations may be used, such as the smooth-faced embodiment shown in FIG. 9, or variable-contour surfaces designed to provide a particular desired reflector assembly inner surface.

In FIGS. 3A and 3B, the inner reflector block 30 is tapered and/or curved in multiple directions to provide close-fitting of its various surfaces to adjacent reflector blocks in a generally cylindrical reflector assembly. The embodiments are not limited to the illustrated tapers, but instead the various sides of the inner reflector block may be shaped as necessary to fit into a reflector assembly in a manner such that the inner reflector block cooperates with adjacent inner reflector blocks to form a reflector ring layer, and preferably minimizes neutron leakage through gaps between blocks.

The FIG. 10 embodiment is a perspective view of a sub-assembly of an inner reflector block 130 and outer reflector block 120. In contrast to the foregoing embodiments, the surface features which support the inner reflector block on the outer reflector block are not vertically-oriented features such as interlocking projections and grooves, but instead are horizontal ledges 126, 136. Preferably the ledges have complementary angled surfaces which cooperate to not only provide a vertical stop supporting the inner reflector block, but tend to resist movement of the inner reflector block 130 up and/or away from the outer reflector block 120 in the radially-inward direction.

FIG. 10 also shows recesses 166 provided to receive the lateral flanges of liner segments, such as those shown in FIG. 2D, to bias the inner reflector block 130 downward against rising vertically along slope of the angled surfaces of the ledges 126, 136.

The use of stop surfaces to support individual inner reflector blocks on an outer reflector block is not limited to strictly angled or horizontally-oriented surface features, as long as the inner reflector block is supported on the outer reflector block in a manner which allows the outer reflector block to individually support an inner reflector block. For example, the ledges of this embodiment may have complementary sides of a “V”-shaped arrangement of surface features, or complementary curved surfaces.

The foregoing disclosure has been set forth merely as illustrative, and is not intended to be limiting. Since modifications of the disclosed embodiments incorporating the spirit and substance of the invention may occur to persons skilled in the art, the invention should be construed to include everything within the scope of the appended claims and equivalents thereof.

1. A neutron reflector, comprising:
an outer reflector block; and
an inner reflector block,
wherein an inner surface of outer reflector block is configured to support the inner reflector block at an outer surface of the inner reflector block, such that a top surface of the inner reflector block does not support a vertical load when in an installed position in the neutron reflector.

2. The neutron reflector of claim 1, wherein
the outer reflector block has circumferential surfaces configured such that, when the outer reflector block is in an installed position in the neutron reflector, the circumferential surfaces of outer reflector block being configured to abut circumferential surfaces of other outer reflector blocks to form a first ring, and
the inner reflector block has circumferential surfaces configured such that, when the inner reflector block is in an installed position in the neutron reflector, the circumferential surfaces of the inner reflector block being configured to abut with circumferential surfaces of other inner reflector blocks to form a second ring concentrically inside the first ring.

3. A neutron reflector, comprising:
a plurality of outer reflector blocks arranged in a first ring; and
a plurality of inner reflector blocks arranged in a second ring,
wherein
an inner surface of each of the plurality of outer reflector blocks faces a center of the first ring,
circumferential surfaces of the plurality of outer reflector blocks face in a circumferential direction of the first ring and are configured to abut the circumferential surfaces of circumferentially adjacent ones of the plurality of outer reflector blocks to form an arc of the first ring,
an outer surface of each of the plurality of inner reflector blocks faces a center of the first ring,
circumferential surfaces of the plurality of inner reflector blocks face in a circumferential direction of the second ring and are configured to abut the circumferential surfaces of circumferentially adjacent ones of the plurality of inner reflector blocks to form an arc of the second ring, and
the inner surfaces of the plurality of outer reflector block are configured to support the plurality of inner reflector blocks at the outer surface of the inner reflector blocks, such that top surfaces of the plurality of inner reflector block do not support a vertical load when in an installed position in the neutron reflector.

4. The neutron reflector of claim 3, wherein
the support of the plurality of inner reflector blocks on the plurality of outer reflector blocks includes the outer surface of at least a portion of the plurality of inner reflector blocks having a surface feature configured to cooperate with a counterpart surface feature of the inner surface of at least a portion of the plurality of outer reflector blocks.

5. The neutron reflector of claim 4, wherein
the surface features are counterpart grooves and projections.

6-20. (canceled)

21. The neutron reflector of claim 5, wherein
the surface features of the outer surfaces of the portion of inner reflector blocks include at least one of the projections and the surface features of the inner surfaces of the portion of outer reflector blocks include at least one of the grooves, or
the surface features of the inner surfaces of the portion of outer reflector blocks include at least one of the projections and the surface features of the outer surfaces of the portion of inner reflector blocks include at least one of the grooves.

22. The neutron reflector of claim 21, wherein
the surface features are configured such that during assembly of the neutron reflector, the surface features interlock.

23. The neutron reflector of claim 4, wherein
the portion of the plurality of inner reflector blocks and the portion of the plurality of outer reflector blocks are configured such that the portion of the plurality of inner reflector blocks are movable vertically relative to the portion of the plurality of outer reflector blocks during assembly of the neutron reflector.

24. The neutron reflector of claim 5, wherein
the counterpart grooves and projections are configured such that the plurality of inner reflector blocks and the plurality of outer reflector blocks cooperate to support the inner reflector blocks at a predetermined height relative to the outer reflector blocks.

25. The neutron reflector of claim 24, wherein
the predetermined height is a height at which the portion of the plurality of inner reflector blocks are supported by the portion of the plurality of outer reflector blocks without further support at a bottom surface of the portion of the plurality of inner reflector blocks.

26. The neutron reflector of claim 25, wherein
the outer surface of each of the portion of the plurality of inner reflector blocks and the inner surface of each of the portion of the plurality of outer reflector blocks cooperate to form a through passage.

27. The neutron reflector of claim 4, wherein
at least one of the plurality of outer reflector blocks and the plurality of inner reflector blocks is formed from graphite.

28. The neutron reflector of claim 27, wherein
the neutron reflector includes a plurality of first ring layers formed from the plurality of outer reflector blocks,
each of the first ring layers supports a respective one of a plurality of second ring layers formed from the plurality of inner reflector blocks, and
the layers are configured to be arranged with the plurality of first rings being stacked on one another and each of the plurality of second ring layers being supported only on and adjacent one of the plurality of outer reflector blocks of the first ring layers.

29. The neutron reflector of claim 4, further comprising:
a plurality of insert elements,
wherein
each of the plurality of insert elements is configured to be located in a through-passage of one of the plurality of inner reflector blocks or one of the plurality of outer reflector blocks, and
at least a portion of the plurality of insert elements is configured to cooperate with a lower end of another one of the plurality of insert elements in a higher one of the reflector layers to form a vertical passage, and with an upper end of another one of the plurality of insert elements in a lower one of the reflector layers, to form the vertical passage.

30. The neutron reflector of claim 4, further comprising:
an insert element configured to be located in a through-passage of one of the plurality of inner reflector blocks or one of the plurality of outer reflector blocks,
wherein the insert element is configured to cooperate with the inner reflector block to resist movement of the inner reflector away from the outer reflector block.

31. The neutron reflector of claim 30, wherein
the gap in the at least one of the plurality of outer reflector blocks extends from a top surface to a bottom surface, and from the outer reflector block inner surface to the through-passage of the at least one of the plurality of outer reflector blocks, and
no portion of the at least one of the plurality of outer reflector blocks bridges the gap.

32. The neutron reflector of claim 5, further comprising:
a plurality of insert elements,
wherein
at least a portion of the plurality of insert elements are configured to be located in a through-passage of one of the plurality of inner reflector blocks, and
each of the plurality of insert elements is configured to cooperate with a respective one of the plurality of inner reflector blocks to resist movement of the respective one of the plurality of inner reflector blocks away from a respective one of the plurality of outer reflector blocks.

33. The neutron reflector of claim 5, wherein
the circumferential surfaces of each of the portion of the plurality of inner reflector blocks include a stepped surface configured to abut a counterpart stepped surface of an adjacent one of the portion of the plurality of inner reflector blocks to inhibit neutron leakage flux through a gap between the adjacent ones inner reflector blocks.

34. The neutron reflector of claim 5, wherein
the circumferential surfaces of each of the portion of the plurality of outer reflector blocks include a stepped surface configured to abut a counterpart stepped surface of an adjacent one of the portion of the plurality of outer reflector blocks to inhibit neutron leakage flux through a gap between the adjacent ones outer reflector blocks.

35. A neutron reflector, comprising:
a plurality of outer means for reflecting neutrons arranged in a first ring; and
a plurality of inner means for reflecting neutrons arranged in a second ring,
wherein
an inner surface of each of the plurality of outer means for reflecting neutrons faces a center of the first ring,
an outer surface of each of the plurality of inner means for reflecting neutrons faces a center of the first ring, and
the inner surfaces of the plurality of outer means for reflecting neutrons includes means for supporting the plurality of inner means for reflecting neutrons at the outer surface of the inner means for reflecting neutrons, such that top surfaces of the plurality of inner means for reflecting neutrons do not support a vertical load when in an installed position in the neutron reflector.
